(19) United States
(12) Patent Application Publication
(10) Pub. No.: US 2016/0289118 A1
(43) Pub. Date: Oct. 6, 2016

(54) Process for Accelerating the Strength of Cement with a Low-Temperature Drying Process for Drying Calcium Sulfite Scrubber Residue Produced from a Wet Flue Gas Desulfurization (Scrubber) System

(71) Applicant: VHSC, LTD., Tortola (VG)

(72) Inventor: Clinton Wesley Pike, Montgomery, TX (US)

(21) Appl. No.: 14/798,527

(22) Filed: Jul. 14, 2015

Related U.S. Application Data
(60) Provisional application No. 62/140,900, filed on Mar. 31, 2015.

(51) Int. Cl. C04B 7/26; C04B 7/02

(52) U.S. Cl. CPC C04B 7/26; C04B 7/02

(57) ABSTRACT

A method is provided for reducing the amount of Old Portland Cement that is to be mixed with interground fly ash in the manufacture of cement having a 120 slag performance by intergrinding fly ash with a dried calcium sulfite scrubber residue from a desulfurization process in which the agglomerated dried calcium sulfite is dried at a low temperature not exceeding 250° F. to increase the strength of the interground fly ash by as much as 40% for allowing the reduction in the amount of Old Portland Cement from 50% to 30%, thus to reduce cement cost.

### CROSS REFERENCE TO RELATED APPLICATION

This application claims benefit of U.S. Provisional Application Ser. No. 62/140,900, entitled, “PROCESS FOR ACCELERATING THE STRENGTH OF CEMENT WITH A LOW-TEMPERATURE DRYING PROCESS FOR DRYING CALCIUM SULFITE SCRUBBER RESIDUE PRODUCED FROM A WET FLUE GAS DESULFURIZATION (SCRUBBER) SYSTEM” filed Mar. 31, 2015, the entire disclosure of which is incorporated herein by reference.

### FIELD OF INVENTION

This invention relates to the manufacture of cement and more particularly to the utilization of calcium sulfite scrubber residue to strengthen cement by limiting the drying temperature of the calcium sulfite sludge, thus to permit reduction of the proportion of Old Portland Cement in the cement mixture.

### BACKGROUND OF THE INVENTION

As described in U.S. patent application Ser. No. 13/647,838 by Clinton Wesley Pike Sr., filed on Oct. 9, 2012, and incorporated herein by reference, a unique multimedia rotary mill is capable of producing cement powder having a 120 slag performance. Fly ash and a polycarboxylic high range water reducer is introduced into the mill, along with other additives. As has been found, this multimedia mill has been able to produce 120 slag performance powder due to the high reactivity of the fly ash ground by the multimedia mill.

This powder is called pozzolanic fly ash and is mixed 50-50 with Portland cement. It is however desirable to reduce the amount of Portland cement and still maintain a 120 slag performance and more particularly to provide a mixture of no more than 30% Old Portland Cement when added to pozzolanic fly ash processed by the aforementioned multimedia rotary mill and attaining Grade 120 slag performance as measured by ASTM C 989 testing. The question therefore becomes how to be able to increase the strength of the pozzolanic fly ash and therefore be able to reduce the amount of Portland cement required. Moreover, it is important to be able to process not only Class C fly ash but also Class F fly ash and provide it with the required strength to be able to reduce the amount of Portland cement.

One of the unsuccessful ways attempted to strengthen the pozzolanic cement was to introduce calcium sulfite as an additive. This calcium sulfite is conveniently available from desulfurization processes for blast furnaces and boilers. However it was found that when either using the undried calcium sulfite scrubber residue from the desulfurization process or heating it to dry it by for instance subjecting it to 400° F., there was no measurable strengthening of the resulting cement

In terms of industry standards, the strength of a cement is determined by comparison to pure cement such that if the SAI rating is 115%, this means that the strength of the powder is 15% better than that of pure cement. If the SAI rating could be raised to 135% then the resulting powder would be 35% stronger. With 35% stronger pozzolanic fly ash then one can reduce the amount of Portland cement required and still maintain the 120 slag performance. How this is accomplished will be described hereinafter.

In terms of the usage of calcium sulfite from calcium sulfite scrubber residue, as indicated by U.S. Pat. Nos. 4,470,850; 4,926,944; 6,099,816; and 5,766,339 calcium sulfite has played a part in cement solidification regulation and as an additive to fly ash cement. Calcium sulfite has also been used as a substitute for the sometimes costly gypsum in the manufacture of cement and a plentiful supply of calcium sulfite is available as a residue from dry flue gas desulfurization processes. However it has never been used with fly ash interground in a multi-media rotary mill. Nor has it been used for cement strengthening.

Thus, while usage of calcium sulfite has been noted, its use to increase the strength of cement has not heretofore been reported.

Since the 1850s calcium carbonate has been used as a reagent to remove sulfur compounds from coal-fired boilers. The first full-scale use of this technology was in London 1931, and it has grown considerably as the accepted way to remove sulfur compounds from the gas stream of coal-fired power plants and other types of coal-fired boilers. In the United States, by 1973, there were six such units to remove sulfur from the emissions from coal fired boilers. By 2000 23 metric tons of waste were being produced from these types of wet scrubbers.

In general, the removal of sulfur-based gases from the atmosphere was then and now a large target in the reduction of stack emissions. Desulfurization can be handled in very different types of scrubbers, but in essence, desulfurization is accomplished by grinding calcium carbonate to around 200 mesh and then injecting the ground down carbonate with water into a gas stream moving upward as it is routed from the coal-fired boilers by huge fan blowers that balance the furnace gases being produced from the pulverized coal combustion pushed out of the boilers. The stoichiometric balance needed for a pulverized fuel to ignite and totally combust in less than a second requires an excess of atmospheric air to allow such combustion. The subsequent injection of the calcium carbonate slurry in a downward force against the upward gases exiting through a scrubber allows the carbonate slurry to be heated and the reaction to change the calcium carbonate to calcium sulfite.

In its basic form calcium sulfite scrubber residue is very high in water content and has to be dewatered to allow any further handling. Typically, vacuum dewaters are used to remove the entrained water to around 15 to 20%. This very wet material is combined with varying amounts of fly ash to allow the sulfite sludge to be stabilized enough to handle.

In the past, the moist calcium sulfite slurry waste product was dewatered in an agglomerator which dried the moist feedstock utilizing hot air. The agglomerated feedstock was then mixed with fly ash and then provided as an input to a rotary kiln in a calcining step in which the slurry/fly ash mixture was desiccated by roasting. Thereafter, the resulting cement clinker was pulverized and used as cement.

Rather than utilizing a rotary kiln and pulverizing, as described in U.S. patent application Ser. No. 13/647,838, a multimedia rotary mill with tailored media has been used to process and grind down fly ash in which the multiple types of media operate differently on the fly ash. In one instance, one type of media crushes relatively large aspherical chunks of fly ash, whereas simultaneously another type of media operates on the fly ash to polish the spherical fly ash without crushing the spheres, both to increase surface area, and thus reactivity. It has been shown that the surface area of such fly ash can be increased by as much as 30%, making the multimedia rotary mill processed fly ash an exceptionally good candidate for cement and concrete.

### SUMMARY OF THE INVENTION

Until the present invention, calcium sulfite slurry has not been successfully used as an additive to strengthen cement. Attempts to use it have been unsuccessful when using either wet calcium sulfite scrubber residue or residue that has been dried using temperatures on the order of 400° F. or higher. It has been unexpectedly found that by drying the calcium sulfite slurry from the desulfurization process at less than 250° F. one can obtain cement that is 20 to 40% stronger than when using either wet slurry or slurry heated above 250° F. This means that cement made by the subject process is so strong that the amount of Portland cement that is mixed with the interground fly ash can be dramatically reduced to as little as 30% without reducing slag performance. Is been found that interground fly ash with an additive of 1-6% of dried sludge exhibits increased strength and a slag performance that exceeds a Grade 120 slag performance. In one embodiment, this increase in strength or performance is occasioned by the use of a very strong poly carboxylate water reducer from Wego introduced at 0.150-0.2% into the multimedia rotary mill. It has also been found that the subject process is preferably used with Class C fly ash. However Class F fly ash can be used.

While the above processing applies generally to traditional methods of manufacturing cement, when the dried calcium sulfite slurry is introduced into a multimedia rotary mill used instead of a rotary kiln and pulverizer, the benefit is that one can use a significantly less amount of Portland cement and still achieve slag 120 performance. For instance if one uses the subject interground fly ash powder one can reduce the amount of Portland cement to 30%. Thus for instance if it takes 500 pounds of Portland cement to be mixed with the Pozzolanic fly ash in a 50-50 mixture, this can be reduced to 450 pounds in a 30-70 mixture due to the increased strength provided by the subject process.

More specifically, it is been found that when calcium sulfite residue from a desulfurization process has been dried at under 250° F., and when this dried sulfite sludge is added to a fly ash mix at 0.5 to 10% depending on the type of fly ash being processed, the result is a mix that can greatly accelerate the strength of a cement/pozzolan mixture. Increased strengths of 20 to 40% have been measured versus any other typical additive. It is been found that it is important that the sludge drying process be performed at lower than 250° F. so that the calcium sulfite does not lose its ability to increase the strengths.

As will be seen, in one embodiment slag performance was assessed using the ASTM C989 testing protocol. When the interground fly ash output from the multimedia rotary mill is mixed with for instance, 30% Type III Old Portland Cement, then the resulting mixture has a ASTM 1157 performance. Thus, pozzolanic fly ash with the dried calcium sulfite slurry can be used to replace Old Portland Cement because of its 20 to 40% increased strength and still exhibit a better than Grade 120 slag performance; or the concrete mix can use a much reduced amount of Old Portland Cement.

In one embodiment, if the base pozzolan is a Class F fly ash, one adds up to 15% Class C fly ash and intergrinds the Class F/Class C mixture with the dried sulfite sludge at 1-6% to optimize strength. Any more than 6% of the dried calcium sulfite scrubber residue can result in an excess of sulfur in the final product.

On the other hand, if the base is a Class C fly ash, sulfite concentrations at 1-6% maximize cement strength. However, as will be appreciated, given the amount alkali in the mix one has to balance the chemistry to make an alkali sulfite resistant (ASR) concrete.

Further, if it is desirable to remove 10 to 15% of the Class C fly ash and add in its place a Class F fly ash or a mineral filler, one uses a minimum of 10 to 15% either of all fly ash or all mineral filter such as silica sand, or 50-50 of each. Note that silica sand gives flexibility to produce an additive when no Class F fly ash is available.

Thus, calcium sulfite residue from a calcium sulfite scrubber is used in the manufacture of a pozzolanic cement in which the moist slurry is dried in a low-temperature drying process, preferably below 250° F. to increase the strength of the cement. When used in a multimedia rotary mill, and when using a high range water reducer, there is a 20 to 40% increase in strength of the cement. This means that a considerably reduced amount of Portland cement needs to be mixed with the interground fly ash and to still obtain Grade 120 slag performance.

In summary, a method is provided for reducing the amount of Old Portland Cement that is to be mixed with interground processed fly ash in the manufacture of cement and still achieve a 120 slag performance by intergrinding fly ash with a dried agglomerated calcium sulfite scrubber residue from a desulfurization process in which the agglomerated dried calcium sulfite is dried at a low temperature not exceeding 250 degrees Fahrenheit to increase the strength of the interground fly ash when added to OPC for ASTM C989 testing by as much as 40%, thus allowing the reduction in the amount of Old Portland Cement the mixture from 50% to 30%, to reduce cement cost.

### BRIEF DESCRIPTION OF THE DRAWINGS

These and other features of the Subject Invention will be better understood in connection with the Detailed Description in conjunction the Drawings, of which:

FIG. 1 is a schematic diagram of a system for utilizing the calcium sulfite scrubber residue in the manufacturer cement through the use of an agglomerator that dewaters the spent absorbent which is heated to less than 250° F., with the dewatered dried sulfite sludge introduced into a multimedia rotary mill where it is in turn interground with fly ash to produce a highly pozzolanic material having increased strength, also showing the mixing of the highly reactive pozzolan with a reduced amount of Old Portland Cement to form a blended cement having 20 to 40% increase strength;

FIG. 2A is a test data chart showing the strength of cement based on raw fly ash, processed fly ash and fly ash combined with calcium sulfite to show the increase in strength due to low heat drying of the sulfite sludge by;

FIG. 2B is a test data chart showing the ability produce slag grade 120 or better cement performance with a reduced Portland cement content to as little as 30% Old Portland Cement due to the increased strength cement; and,

FIG. 3 is a diagrammatic representation of a multimedia rotary mill utilize in one embodiment of the subject process in which the mill is provided with tailored media to act differently on aspherical fly ash and spherical fly ash for the purpose of increasing the surface area of the inter-ground output and thus its reactivity.

### DETAILED DESCRIPTION

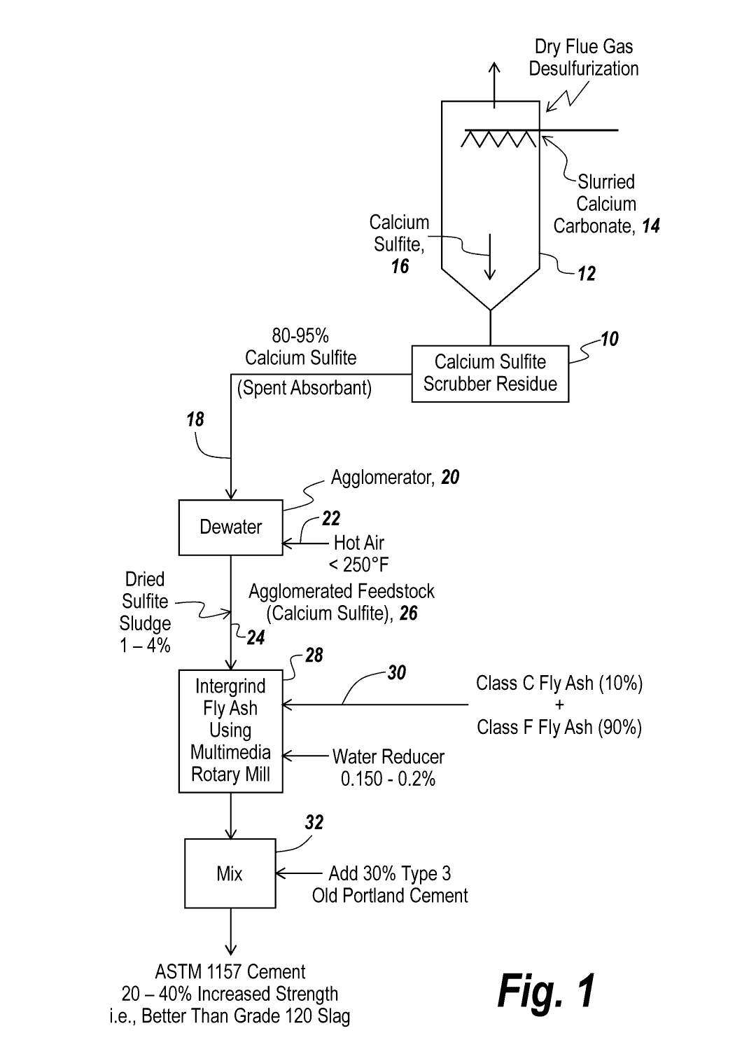

Referring now to FIG. 1, a process is shown for utilizing calcium sulfite scrubber residue in the manufacture of cement. The calcium sulfite residue 10 is the result of the desulfurization process in a chamber 12 which de-sulfurizes dry flue gas by the injection of slurried calcium carbonate 14 in a downward direction where the calcium carbonate reacts with upwardly directed flue gas such that the reaction produces calcium sulfite 16.

The calcium sulfite is in the form of a moist spent absorbent, with the absorbent containing 80-95% calcium sulfite. This is conveyed by conduit 18 to an agglomerator 20 the purpose of which is to dry the moist scrubber residue in a dewatering process in which hot air 22 is introduced into the agglomerator specifically at a temperature less than 250° F. The result is a dried sulfite sludge available at conduit 24 which constitutes an agglomerated feedstock of calcium sulfite 26. In one embodiment this dried sulfite sludge is introduced into a multimedia rotary mill 28 in which a supply of fly ash is introduced by conduit 30. The dried sludge is introduced at 1-6% by weight into the multimedia rotary mill 28, with a poly carboxylate water reducer 32 introduced into the multimedia rotary mill 28 at 0.150-0.2% in one embodiment. The output of the multimedia rotary mill 28 is introduced to a mixer 32 to which is added 30% Type III Old Portland Cement to produce a ASTM 1157 cement having a 20-40% increased strength with a better than Grade 120 Slag performance.

The increased strength is due to the action of the sulfite when mixed with surface area increased fly ash. The subject process in one embodiment uses either majority of Class C fly ash with Class F fly ash, or the majority of Class F fly ash with Class C fly ash.

Note that in the process of producing activated slag utilizing the multimedia rotary mill, called Pozzoslag, it was discovered that calcium sulfite dried at under 250° F. when added to the mix at 0.5-10% depending on the type of fly ash being processed can accelerate the strength of the cement/pozzolan mixture by 20-40% as opposed to any typical additive. Is important to note that the drying process has to operate at low temperature which does not affect downstream strengthening, for instance below 250° F. If the temperature is above 250° F., the calcium sulfite loses its ability to increase strength.

From the test results presented below, several different types of fly ash exhibited very substantial increases in strength.

For those fly ashes to which no dried sulfite sludge was added, they did not reach a grade 80 slag performance. However when calcium sulfite was added in the ranges described above, all test cubes exceeded the Grade 120 slag performance requirement under the ASTM C989 testing protocol. Note that tests are run on a number of fly ash materials that could not pass the grade 80 slag index, but after utilization of the dry calcium sulfite residue began to pass the Grade 120 slag performance requirement due to the increase in strength of the cement.

In the process described above no unique material was noted in XRD examination and thus no reactionary trace materials were found. Not only was it discovered that one has to dry the scrubber sludge at a fairly low temperature, it was also discovered that it is beneficial to utilize a very strong water reducer at 0.150-0.2% such as polycarboxylate from Wego to obtain the increased rates in an ASTM cube testing procedure.

Without the drying procedure described above as well as the use of a very strong water reducer, any increase in strength due to the use of the sludge is not enough to consider.

Further, even when using a fly ash that has a surface area only increased by 15-20% by the unique multimedia rotary mill described herein, one can nevertheless obtain Grade 120 slag performance. This can be done with a 70% replacement of Old Portland Cement with Pozzoslag and the remainder a structural filler comprising 8% of a ground down silica filler with a 9-16 micron mean, with 60% passing 10 microns, and a top size of 35 microns.

It also was found that by using 10% by weight of Class C fly ash blended with Class F fly ash, the addition of the Class C fly ash to Class F fly ash not only results in the aforementioned strength increase, it allows one to spend less time in the rotary mill to achieve the same activity results. This means that the resulting cement passes the Grade 120 slag activity with only 20 minutes in the rotary mill as opposed to 50 minutes. The increased strength cement can thus be produced in less than half the time.

Note that all Class C fly ashes tested have 0.2% or less polycarboxylate content and a 20% surface area increase. With just 1-4% of the 250° F. dried sludge, a well-over grade 120 activity is produced.

The surprising result of the subject invention is that with sulfite there is an optimal drying temperature and that by providing a mixture of Class C and Class F fly ash one can maximize the sulfite results. Thus, it is been found that if the base pozzolan is a Class F fly ash one can add up to 15% Class C fly ash, with the 1-6% sulfite concentration optimizing strength. If on the other hand one is using a Class C fly ash, 1-6% sulfite concentrations maximize strength, although there is a need for other chemical changes. Specifically one needs to balance the chemistry, given the amount of alkali in the mix, to make an Alkali Sulfate Resistant (ASR) concrete.

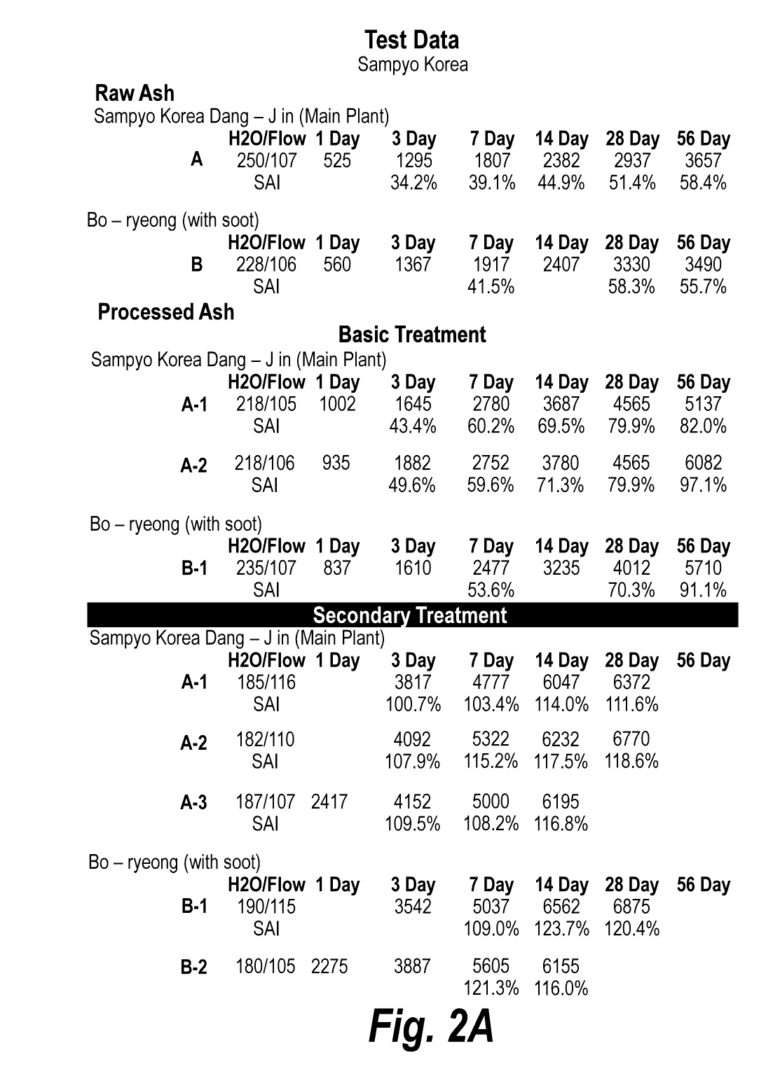

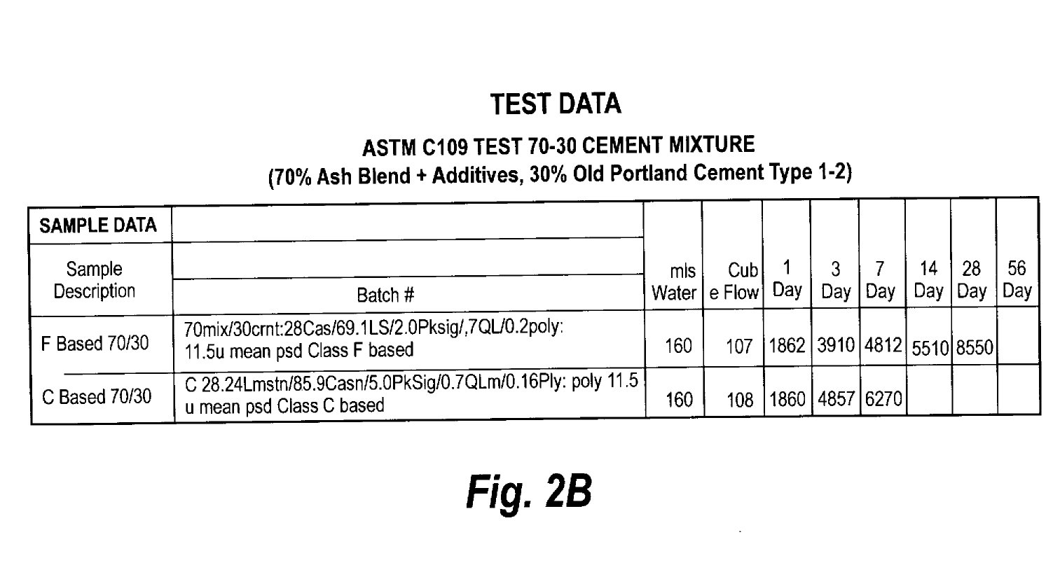

As to the test results and referring now to FIG. 2A, it can be seen that fly ash from Sampyo Korea Dang and Bo-ryeong was used. Note that Sampko Korea Dang fly ash J in the main plant was used, whereas in Bo-ryeong the fly ash contained soot. From the Test Data of FIG. 2, it will be seen that this data is arranged by raw ash, meaning untreated ash, processed ash meaning processed in a multimedia rotary mill and the secondary treatment which refers to processing in the multimedia rotary mill with the subject calcium sulfite derived from desulfurization.

In the Table of FIG. 2A, all of the testing involved 50% pozzolanic fly ash and 50% Old Portland Cement. Samples from two plants, namely Sampyo Korea Dang and Bo-ryeonh, are separately presented for raw ash, processed ash secondary treatment processes. These samples are labeled A, B, A-1, A-2, A-3, B-1 and B-2.

For each of the samples the H2O/flow is indicated having allowable parameters, with the one day, three-day, seven day, 14 day, 28 day and 56 day tests indicating in terms of psi the amount of pressure to cause a test cube of the corresponding cement to fail. The following describes strength increases only for the 28th day figures are analyzed, with the failure psi for each test cube followed by the SAI or Strength Activity Index. Note that the strength activity index is expressed in terms of a percent strength when compared with a test cube of pure cement. Thus an SAI of 120.4% means that there is a 20.4% increase in strength over a test cube of pure cement. With this understanding, the results of the Table in FIG. 2A are now discussed:

As can be seen, the strength activity index or SAI is the principal measure of strength used here. For purposes of comparison taking the 28 Day strength, with raw ash for both the plants the SAI was respectively 51.4% and 58.3 percent, meaning that the 28^{th} day strength was only 51-58% of pure cement. For processed ash, meaning processed in a multimedia rotary mill, the 28^{th} day strength was around 79.9% and 70.3% respectively. Comparing this to utilization of dried calcium sulfite sludge, 28 day strengths were for Sampyo Korea Dang 111.6%, and 118.6% and for Bo-Ryeong 120.4%. This means that the cements averaged strengths of between 111.6% and 120.4%. From a percentage increase point of view this translates to 20-40% strength increase. The remainder of the data for one day, three-day, five day, 14 day, 28 day and 58 day measurements shows like increases when using calcium sulfite sludge.

Referring now to FIG. 2B, having shown significant strength increase when using the subject calcium sulfite sludge process and a 50-50 mixture, this increased strength makes possible the reduction of Old Portland Cement from 50% of the mixture to 30% of the mixture while still maintaining a better than 120 slag performance. In FIG. 2B, with Class F fly ash the 28^{th} day strength activity index is an impressive 8550. This translates into a well over 120 slag performance, substantiating that when using the calcium sulfite sludge process, one can reduce the Old Portland Cement in the mixture to as little as 30%.

With respect to Class C fly ash the data shows that for seven day strength, the strength activity index is 6270, again showing a considerable increase in strength making possible the reduction of Old Portland Cement in the mixture. From the strength progression from day one, to day three and then to day seven, the progressive strength increase from 1860 to 6270 is at a greater rate than the same period for the Class F fly ash. Thus, the 28 day strength activity index for Class C fly ash is expected to be well over that associated with Class F fly ash, clearly establishing that is possible to dramatically decrease the amount of Old Portland Cement when using the subject calcium sulfite sludge process.

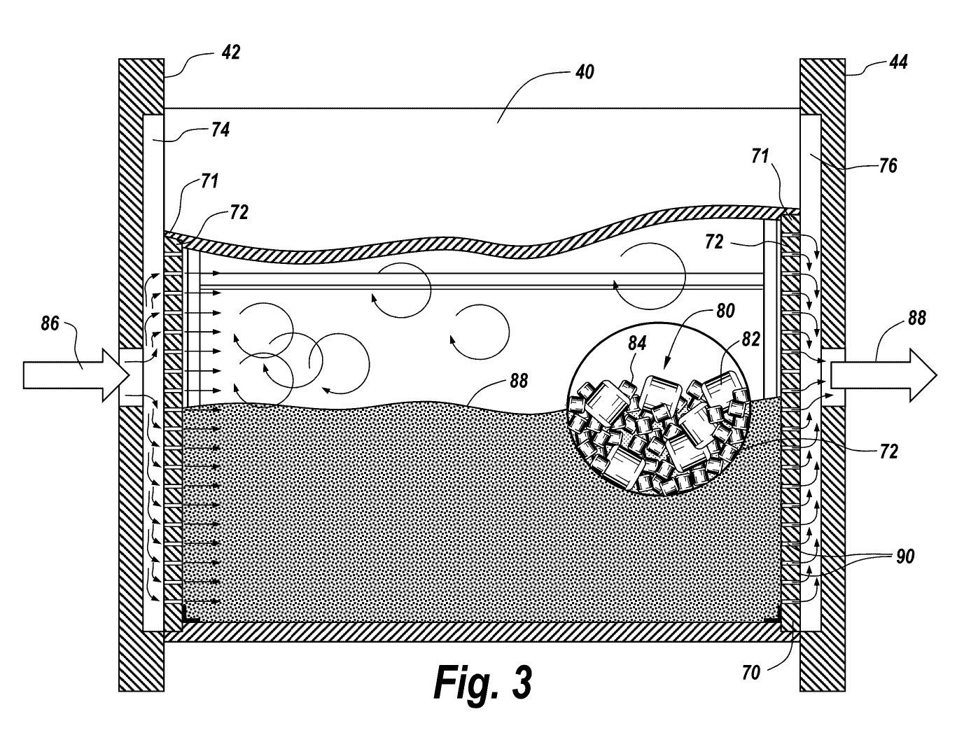

Referring now to FIG. 3, what is shown is a diagrammatic illustration of a specialized rotary mill having a tailored media which operates differently on for instance aspherical fly ash and spherical fly ash to increase the surface area thereof. Note that to increase the surface area of fly ash, the multimedia rotary mill employs different sizes and shapes of ceramic media. It is been found that fly ash can be rotary milled to achieve a total of surface area around 1.263 m2/g or higher starting at 0.695 m2/g. Thus one can increase the surface area of all particles and especially the spherical particles.

The surface area of both non-spherical and spherical particles can be increased by crushing non-spherical particles and by roughing up the surface of the spheres. Both types of articles are treated in the mill using a tailored mix of ceramic media. Thus while one is not actually fracturing the small spherical particles, the mill nonetheless beats them up utilizing the tailored media so as to increase the surface area of small spherical particles to activate them while the same time grinding non-spherical particles to a smaller and smaller diameter to provide increased surface area.

Note that rotary mill 10 is filled with a multimedia charge. Drum 40 is shown with slotted plates 71 that communicate with an input plenum 74 and output plenum 76 through end plates 42 and 44. Drum 40 is preloaded with a tailored charge of ceramic media, here shown at 80 to include different sized ceramic media 82 and 84. The formulation determines the amount of grinding of the fly ash introduced into drum 40 as illustrated at 86 and occupies at least one third of the volume of drum 40 as illustrated at 88.

In one embodiment, when the pre-ground fly ash has been ground by the rotary mill for 45 minutes, the activated fly ash 88 is ejected through slits 42 in exit plate 71.

As to the constituency of the multimedia, this formulation can be tailored as indicated above. In one example the formula for the media may include one half inch cylindrical ceramic media, ¼ inch cylindrical ceramic media, three-quarter inch cone shaped ceramic media and 8 mm beads. In another formulation one can use a mixture of ⅝ inch cylinders with three-quarter inch cones and ⅛ inch cylinders, it being understood that there are many different media combinations that may be used in combination with different types of fly ash and different residence times. For instance, depending on the media formulation one can lower the residence time from for instance one hour to less than 45 minutes.

Thus rotary mill 40 can create multiple components differently depending on the mix of media in the mill and the configuration thereof. Specifically with respect to the treatment of pre-ground fly ash to provide activated fly ash, the differently configured media acts differently on the aspheric fly ash as opposed to the spherical beads. In the case of aspherical fly ash particles, they are further ground down without cracking or grinding any spherical fly ash particles. On the other hand, the spherical glass beads are polished to rough of their surfaces. In both cases the surface area of fly ash particles is increased. Thus, for the aspherical particles the increased surface area is performed by grinding, whereas for the glass beads, the increased surface area is roughened by roughening up the surface of beads.

Although this specialized rotary mill has been shown to be able to provide cement having a slag performance equal to or better than 120 slag performance, the mill can be made to produce stronger cement and to the extent that it can be made stronger, less Portland cement needs to be mixed with it in order to provide the requisite slag performance. Thus strength increase is key to the reduction of the amount of Old Portland Cement needs to be used, with the subject strength increase coming from the specially dried calcium sulfite scrubber residue, in plentiful supply from desulfurization processes associated with boilers and power plants.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for increasing the strength of cement comprising the steps of:
obtaining a supply of calcium sulfite scrubber residue;
agglomerated the calcium sulfite residue by heating the residue at a low temperature to dry it; and,
using the agglomerated dried calcium sulfite residue in the manufacture of cement, such that the cement strength is increased due to the low temperature processing of the calcium sulfite residue.

2. The method of claim 1, wherein the cement is manufactured in a multimedia rotary mill.

3. The method of claim 2, wherein the agglomerated and dried calcium sulfate residue is introduced into the multimedia rotary mill such that the strength of the cement from the multimedia rotary mill is increased by at least 20% over that obtainable from the mill without the introduction of the agglomerated dried calcium sulfite residue.

4. The method of claim 2, and further including the step of introducing a hat high range water reducer into the multimedia rotary mill.

5. The method of claim 1, wherein the manufacture of cement includes mixing fly ash with the agglomerated dried calcium sulfite residue.

6. The method of claim 5, wherein the fly ash includes Class C fly ash.

7. The method of claim 5, wherein the fly ash includes Class F fly ash.

8. The method of claim 5, wherein the fly ash includes a combination of Class C fly ash and Class F fly ash.

9. The method of claim 1, wherein the manufacture of cement includes intergrinding the fly ash with the agglomerated dried calcium sulfite residue in a multimedia rotary mill.

10. The method of claim 9, wherein the fly ash includes Class C fly ash.

11. The method of claim 9, wherein the fly ash includes Class F fly ash.

12. The method of claim 9, wherein the fly ash includes a combination of Class C fly ash and Class F fly ash.

13. The method of claim 1, wherein the low temperature is less than 250° F.

14. The method of claim 1, wherein the cement is a mixture of interground fly ash and Old Portland Cement, wherein the agglomerated dried calcium sulfite scrubber residue increases the strength of the interground fly ash and wherein the increased strength of the interground fly ash permits the reduction of the amount of Old Portland Cement in the cement mixture.

15. The method of claim 14, wherein the amount of Old Portland Cement in the cement mixture is no greater than 30%.

16. The method of claim 14, wherein the interground fly ash is manufactured in a multimedia rotary mill.

17. The method of claim 16, wherein the dried calcium sulfite scrubber residue is introduced into the multimedia rotary mill along with a high range water reducer.

18. The method of claim 17, wherein the temperature at which the calcium sulfite scrubber residue is agglomerated is less than 250° F.

19. In a cement manufacturing operation in which fly ash is interground with agglomerated calcium sulfite scrubber residue in a multimedia rotary mill, a method for reducing the amount of Old Portland Cement used in the manufacturing operation involving the mixing of Old Portland Cement with the interground fly ash, comprising the steps of:
drying the calcium sulfite scrubber residue at a temperature low enough so that the strength of the interground fly ash is increased to the extent that a lower amount of Old Portland Cement may be used in the cement manufacturing operation while still obtaining at least a 120 slag performance; and,
mixing the interground fly ash with Old Portland Cement such that the normal 50-50 mixing of the interground fly ash with Old Portland Cement is replaced by mixing only 30% of the Old Portland Cement with the interground fly ash.

20. The method of claim 19, wherein the low temperature is below 250° F.

21. The method of claim 19, wherein intergrinding in the multimedia rotary mill includes grinding the fly ash with the dried calcium sulfite scrubber residue with a high range water reducer.

22. The method of claim 19, wherein the fly ash includes Class C fly ash.

23. The method of claim 19, wherein the fly ash includes Class F fly ash.
